(19) United States
(12) Patent Application Publication
(10) Pub. No.: US 2008/0235122 A1
(43) Pub. Date: Sep. 25, 2008

(54) MASTER GIFT CARD, SYSTEMS AND METHODS

(75) Inventor: Felix Weitzman, Conifer, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/689,602

(22) Filed: Mar. 22, 2007

(51) Int. Cl. G06Q 40/00

(52) U.S. Cl. 705/35

(57) ABSTRACT

Stored value instruments and tools for their use and/or administration are disclosed. In an aspect, a stored value instrument is associated with a subaccount that has access to a portion of an amount stored value in a master account. There may be many such subaccounts associated with a master account, and each subaccount may have its own associated stored value instrument. Beneficially, this arrangement can allow a master account holder to assign a specific portion of the stored value in the master account for the use of each of the stored value instruments, while still maintaining the ability to administer the master account.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to stored value instruments in general and in particular to tools for providing stored value instruments that are associated with a subaccount of a master account.

### BACKGROUND

Stored value cards, a relatively recent phenomenon, have seen increasing use over the past several years. As used herein, the term “stored value card” means any payment instrument that can be used to purchase products and/or services using a positive balance of funds maintained in an account associated with that instrument. In some cases, a stored value card may be associated with a debit account (such as a checking account, etc.) at a financial institution. More commonly, however, a stored value card is associated with a specific account containing a discrete amount of funds assigned at the time of (or before) the purchase of the stored value card.

Stored value cards provide several advantages over other forms of payment. Merely by way of example, stored value cards can provide the convenience of a credit card, without a credit card's attendant disadvantages, for purchasers who cannot, or choose not to, use an interest-bearing purchase instrument. Such purchasers can include, without limitation, persons without sufficient credit to obtain a credit card, purchasers who receive stored value cards as gifts, employees purchasing items on an expense account who are not provided with company credit cards, and/or the like. Further, stored value cards can provide additional security for cardholders, because any financial risk associated with the stored value card generally is limited to the amount of funds in the account associated with the stored value card. In addition, because stored value cards typically do not identify their users to the same degree as other payment instruments (e.g., checks, credit cards, and/or the like), stored value cards prevent a much lower risk of identity theft.

Despite these advantages, stored value cards often are not an ideal payment solution for many purchasers. Merely by way of example, an employer might wish to provide employees with stored value cards for businesses expenses. A typical stored value card, however, will not provide the same type of control over business purchases as other payment instruments. For instance, credit cards may allow an employer to audit and/or control expenditures made with the credit card, while, in the past, stored value card, by their nature, have prevented this functionality.

Moreover, in the past, stored value cards have imposed administrative inconveniences, preventing their effective use in some circumstances. Merely by way of example, if an employer wished to provide several employees with stored value cards, the employer was forced to purchase such cards individually. Further, many stored value cards, after a specified period of disuse, will expire (either on a depreciating basis or immediately after the specified period), and the funds in the account associated with the stored value card typically will escheat to the state. Accordingly, an employer wishing to provide stored value cards to its employees would have to monitor the use of those cards carefully, in order to prevent timely use of the cards to avoid needless waste of the employer's funds through this use of the cards. This issue is compounded by the lack of monitoring tools available for stored value card usage.

Hence, there is a need for stored value instruments with enhanced flexibility.

### BRIEF SUMMARY

Embodiments of the invention provide novel stored value instruments (including, inter alia, stored value cards) and tools for their use and/or administration. Such tools can include, without limitation, methods, systems and/or software programs for maintaining and/or administering and accounts associated with stored value instruments. In an aspect of some embodiments, a stored value instrument is associated with a subaccount that has access to a portion of an amount of stored value in a master account. There may be many such subaccounts associated with a master account, and each subaccount may have its own associated stored value instrument. Beneficially, this arrangement can allow a master account holder to assign a specific portion of the stored value in the master account for the use of each of the stored value instruments, while still maintaining the ability to administer the master account.

In another aspect, certain embodiments allow a holder of a stored value instrument to maintain a balance of independent stored value associated with the instrument. In this way, the instrument holder has the ability to augment the stored value made available by the master account holder. Optionally, in such embodiments, the instrument holder may be provided with the ability to prioritize either the independent stored value or the stored value shared with the master account, such that charges against the account our first debited from the prioritized stored value.

In some cases, the master account holder is provided with access to information about the master account and/or one or more of the subaccounts. This information can include, merely by way of example, information about purchases made with the stored value instruments. In this way, the master account holder can be given the ability to audit the use of stored value instruments associated with the master account's subaccounts. (In one aspect, while the master account holder may be given access to financial information associated with a shared amount of stored value in a subaccount, such access may be withheld from the master account holder with respect to financial information associated with an independent balance of stored value, providing the instrument holder with privacy regarding the independent balance, which may be the sole responsibility of the instrument holder.)

In accordance with some embodiments, other tools may be provided to facilitate control by the master account holder over spending by the instrument holder(s). Merely by way of example, the master account holder may be provided with the ability to set periodic spending limits for one or more of the subaccounts. For instance, the master account holder might specify a maximum amount of shared value (or, more precisely, in some cases, shared stored value) in the subaccount that can be used over any given period (such as a day, month, quarter, year, and/or the like).

The tools provided by various embodiments invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

Merely by way of example, one set of embodiments provides methods, including without limitation methods of providing financial services. An exemplary method comprises maintaining (e.g. a host computer system and/or in a database) a master account. In an aspect, the master account has a master amount of stored value and/or is associated with a master account holder, who is responsible for the master account.

In some embodiments, the method further comprises creating (e.g. at the host computer system and/or in the database) a first subaccount, which may be subordinate to the master account. Merely by way of example, the first subaccount might have access to a first amount of stored value, which comprises a first portion of the master amount of stored value. The first subaccount may have access to this first portion of the master amount of stored value.

The method may further comprise creating a second subaccount, which also may be subordinate to the master account. Hence, the second subaccount might have access to a second amount of stored value which might comprise a second portion of the master amount of stored value. Accordingly, the second subaccount may have access to this second portion of the master amount of stored value.

In a set of embodiments, the method comprises initiating issuance of a first stored value instrument to a first instrument holder. The first stored value instrument may provide access to the first subaccount. Similarly, the method might comprise issuing a second stored value instrument, which provides access to the second subaccount, to a second instrument holder. In a particular embodiment, a master stored value instrument may be issued to a holder of the master account. This master stored value instrument may provide access to the master account.

Any of a variety of stored value instruments may be supported in accordance with embodiment in the invention. Merely by way of example, a gift card (which might comprise a magnetic stripe, a barcode and/or like) may be used as a stored value instrument. In some embodiments, a stored value instrument may be configured for use on a credit card network, such that the stored value instrument is used to process a credit card transaction.

Another set of embodiments provide systems, including without limitation, systems for providing financial services. An exemplary system comprises one or more processors and a database in mitigation with the processor(s). The database may be configured to store information about a plurality of stored value accounts. The system may further comprise a computer readable medium having stored thereon a set of instructions executable by the processor(s).

The set of instructions might include, merely by way of example, instructions for maintaining, in the database, a record for a master account having a master amount of stored value. The master account may be associated with a master account holder, who is responsible for the master account. The set of instructions might further comprise instructions for creating, in the database, records for one or more subaccount, which are subordinate to the master account. Each subaccount might have access to an amount of stored value that comprises a portion of the master amount of stored value. There may also be instructions for initiating issuance of stored value instruments that provide access to the subaccounts.

In a particular embodiment, the system further comprises an interface configured to allow communication between one or more users and the one or more processors. The set of instructions, then, might include instructions for receiving instructions from the master account holder for managing the master account. In another embodiment, the system might comprise a card issuing system configured to issue the stored value instrument in response to the instructions to initiate issuance of the instruments.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification of an existing sublabel, it is intended to refer to all such multiple similar components.

FIG. 1 is a block diagram illustrating a computer system for providing financial services, in accordance various embodiments of the invention.

FIG. 2 is a block diagram illustrating an account structure within a database, in accordance with various embodiments of the invention.

FIG. 3 is a process flow diagram illustrating a method of providing financial services, in accordance with various embodiments of the invention.

FIG. 4 is a process flow diagram illustrating a method of applying stored value to a debit transaction, in accordance with various embodiments of the invention.

FIG. 5 is a process flow diagram illustrating various procedures for managing an account and/or a subaccount, in accordance with various embodiments of the invention.

FIG. 6 is a process flow diagram illustrating a method of providing a prepaid negotiable instrument, in accordance with various embodiments of the invention.

FIG. 7 is a generalized architectural diagram illustrating a computer system that can be used in accordance with various embodiments of the invention.

FIG. 8 is a generalized block diagram illustrating a networked system of computers that can be used in accordance with various embodiments of the invention.

### DETAILED DESCRIPTION OF THE INVENTION

Embodiments of the invention provide novel stored value instruments (including, without limitation, stored value cards) and tools for their use and/or administration. Such tools can include, without limitation, methods, systems and/or software programs for maintaining and/or administering and accounts associated with stored value instruments. In an aspect of some embodiments, a stored value instrument is associated with a subaccount that has access to a portion of an amount stored value in a master account.

As described in further detail herein, various embodiments of the invention proved enhanced flexibility in the allocation and/or administration of stored value among a master account and various subaccounts. As used herein, the term “stored value” means any amount of value that is stored in an account (e.g., a master account and/or a subaccount), based on funds deposited (or otherwise provided) in advance. In some, but not all, cases, a stored value account might be maintained at a financial institution. As used herein, the term “account” means any collection of data that is used to keep a record of an amount of stored value.

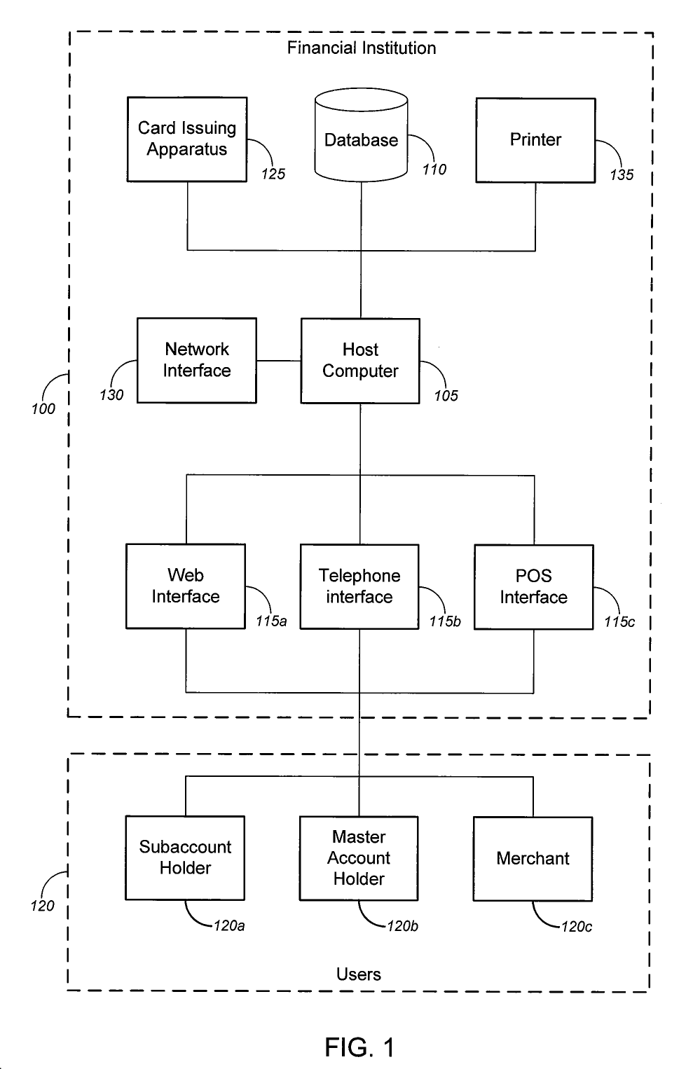

In some cases, stored value will be managed by a computer system at a financial institution. FIG. 1 illustrates a system 100 for providing financial services (including providing and/or managing stored value accounts) in accordance with one set of embodiments. In accordance with various embodiment of the invention, a financial institution can be any of a variety of entities. Merely by way of example, in some cases, the financial institution might be a bank. In other cases, the financial institution might be a credit card issuer, a money transfer service, a brokerage firm, a money management firm, a retailer, and/or the like. The nature of the financial institution is not material to the scope of the invention, and it should be appreciated that wide variations are possible in accordance with various embodiments.

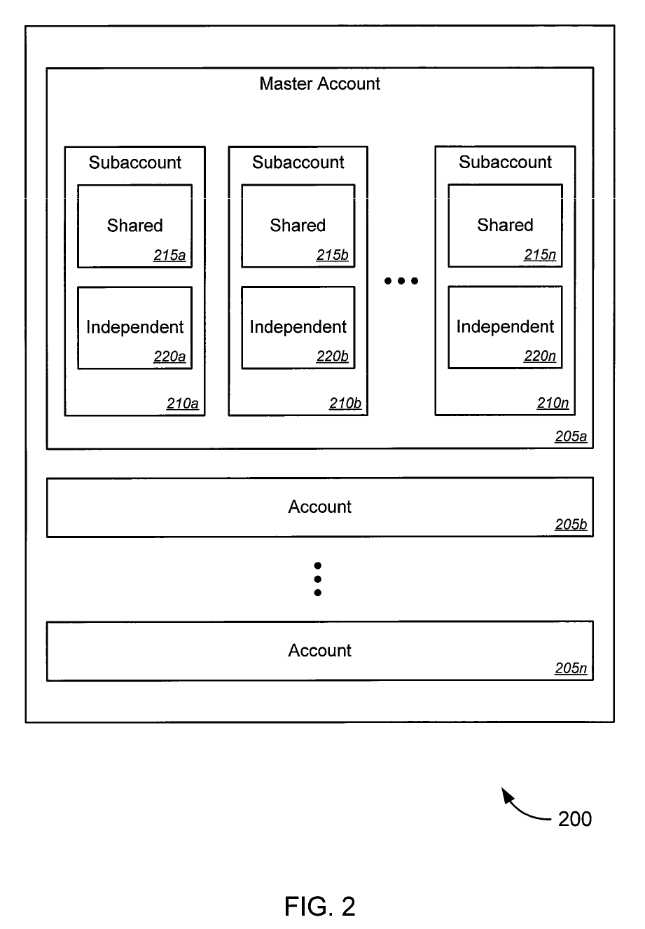

In a set of embodiments, the system comprises a host computer 105. The host computer 105 may comprise one or more computers and may employ any of a variety of architectures. Merely by way of example, in some cases, the host computer 105 might be a server computer, such as a mainframe, a minicomputer, a UNIX- or Windows-based server computer, and/or any combination thereof. In an aspect, the host computer 105 is capable of processing financial transactions. One skilled in the art will appreciate, based on disclosure herein, that there are a variety of commercially available computer systems capable of functioning as the host computer 105. In one set of embodiments, the host computer 105 is in communication with (and/or comprises) a database 110 that can be used to store data representing a plurality of accounts (which can include, without limitation, stored value accounts such as master accounts and/or subaccounts in accordance with embodiments of the invention). A typical account structure in accordance with one set of embodiments is described in further detail below with respect to FIG. 2.

The host computer 105 also comprises (and/or is in communication with) one or more interfaces 115 for providing communication with various users 120. Merely by way of example, there may be a web interface 115a (which might comprise a web server, application server and/or the like, each of which might execute on the host computer 105 and/or on another server in communication with the host computer 105) to allow communication between the host computer 105 and a user 120 using a web browser. (Other computer interfaces with users 120 can be employed as well. Merely by way of example, the host computer 105, and/or another computer in communication therewith might have a server component configured to communicate with a dedicated client program on a computer operated by a user 120). As another example, in some embodiments, the system 100 comprises a telephone interface 120b, such as an interactive voice response (“IVR”) system that allows a user to communicate with the host computer 105 over a telephone connection. Yet another example of an interface 120 is a point of sale (“POS”) interface 120c, which can include a POS device at an agent location, a merchant location, and/or the like. (In some embodiments, the POS interface might include a merchant employee and/or an employee or agent of the financial institution, such that employee/agent might provide communication, via a POS device, between a user 120 and the host computer 105. Other types of interfaces are possible as well.

The system 100 might have a variety of users 120 with different roles. Merely by way of example, a subaccount holder 120a might have access and/or authorization to use and/or manage (perhaps subject to constraints described in further detail below) stored value in one or more subaccounts, in accordance with embodiments of the invention. A master account holder 120b might have authority and/or responsibility for a master account (as well as, in some cases, access to some or all of the information about subaccounts under the master account and/or authority to manage certain aspects of such subaccounts, as described in further detail below). A merchant 120c might communicate with the host computer 120c to authorize and/or validate transactions made with a stored value instrument and/or a prepaid negotiable instrument, as described in further detail below. Any of these users 120 may use any one or more appropriate interfaces 120 for communicating with the host computer.

In accordance with some embodiments, a stored value account (which may be, inter alia, a subaccount and/or master account) may have associated therewith a stored value instrument (of which a stored value card is but one example) that provides access to that account (i.e., can be used to purchase goods or services using stored value in the account. Thus, the host computer 105 may further comprise (and/or be in communication with) a card issuing system 125. The card issuing system 125 can be used to produce (and/or prepare for distribution) stored value instruments, such as stored value cards, in accordance with embodiments of the invention. Merely by way of example, the card issuing system 125 may be configured to print, store on a pre-printed card, or otherwise produce a stored value instrument, and/or to send the instrument to the instrument holder (or another appropriate party).

In an aspect, a stored value card may comprise a human-readable identifier (e.g., a printed and/or embossed identifier, etc.), and/or a magnetic stripe, bar code, and/or the like that allows the stored value card to be machine readable (e.g., to allow a machine, such as a point of sale (“POS”) device, ATM, etc. to obtain from the stored value instrument information, such as an account number, personal identification number (“PIN”), and/or the like, necessary to complete a transaction using the stored value instrument). Hence, a stored value card may be configured to be used, for example, online, by a user who provides the card identifier (which is associated with the account to which the card has access) and/or PIN; additionally, and/or alternatively, a stored value card may be configured to be used by swiping the card through a POS device that sends the relevant information to the host computer 105. Merely by way of example, a stored value card in accordance with some embodiments may be configured for use in a credit card network, such as the Visa™ network, the MasterCard™ network, and/or the like. In other embodiments, the stored value card might be configured for use in an automated teller (“ATM”) network. Accordingly, the system might further comprise a network interface 130 (comprising hardware, software and/or both) configured to allow communication between the host computer 105 and other financial institutions, one or more credit card networks, one or more ATM networks, an automated clearinghouse (“ACH”) and/or the like, to facilitate the initiation and/or clearing of transactions made using a stored value instrument. Such interfaces and communications are familiar to one skilled in the art and need not be described in detail herein.

In some embodiments, as described in further detail below, a prepaid negotiable instrument may be used to access prepaid value in a subaccount and/or a master account. Accordingly, in such embodiments, the system 100 may include a printer 135, which can be configured (e.g., with magnetic ink, etc.) to print prepaid negotiable instruments. (In other cases, the printer 135 may be used for other purposes, such as for printing account usage reports, receipts, and/or the like.)

In some cases, the card issuing system 125 and/or the printer 135 may be remote from the host computer 105. Merely by way of example, a printer 130 may be located at an agent location, a merchant location, a centralized printing facility, and/or the like. Similarly, the card issuing system 125 may be located a centralized card issuing facility, at the location of a third-party provider responsible for issuing cards, and/or the like.

In an aspect, embodiments of the invention provide the ability for a particular stored value account to have associated therewith one or more subaccounts. As used herein, the term “subaccount” means a stored value account that is part of, and/or is otherwise associated with, a master account. A “master account” is a stored value account that comprises (and/or has associated therewith) one or more subaccounts. FIG. 2 illustrates a database 200 comprising information (which, as noted above, might be stored as records, tables, etc. in the database 200) about a plurality of stored value accounts 205. The database 200, in some embodiments, functions as the database 110 described with respect to FIG. 1 above.

A stored value account 205a may be a master account, in that it may have associated therewith one or more subaccounts 210. There are various ways in which a subaccount 210 may be associated with a master account 205a. Merely by way of example, in a database, there may be records for the master account 205a and any associated subaccounts 210, and/or the records may be linked to reflect the master-subaccount relationship. In other embodiments, a subaccount 210 might be represented by a set of fields in a database record for a master account 205a. In yet other embodiments, a master account 205a might be represented by a table, and a subaccount 210 might be represented by a row within that table (and/or a linked table). One skilled in the art will appreciate, based on the disclosure herein, that there are a variety of ways in which the relationship between a subaccount 210 and a master account 205a might be represented.

In an aspect, however, all of these relationships have in common the fact that the subaccount 210 has access to (i.e., can use) at least a portion of the stored value in the master account 205a. This portion is sometimes referred to herein as “shared stored value,” 215 in that it is stored value that is held by the master account 205a, but which is available to (shared with) the subaccount 210. In a sense, therefore, each subaccount is subordinate to the master account, in that it has access to an amount of stored value that is a portion (i.e., some or all) of the stored value in the master account. There may be several subaccounts 210a-c, each of which shares a portion 215a-c, respectively, of the stored value in the master account. (The total amount of the shared portions of the master account's stored value can, but need not necessarily, equate to the amount of the stored value in the master account.)

In an aspect, each subaccount 210 may have its own associated stored value instrument. Beneficially, this arrangement can allow a master account holder to assign a specific portion of the stored value in the master account for the use of each of the stored value instruments, while still maintaining the ability to administer the master account. A stored value instrument for a particular subaccount 210 may also provide access to the balance of any independent stored value 220 (described in further detail below) in the subaccount 210 as well. The stored value instrument is held by an “instrument holder,” who generally is the same entity as the “subaccount holder” (i.e., the entity with access to the stored value in the subaccount 210) for the subaccount 210 associated with the stored value instrument. (Of course, a stored value instrument may be provided for the master account 205a itself, in which case the master account holder—the entity with responsibility and/or authority over the master account itself—would also be an instrument holder.)

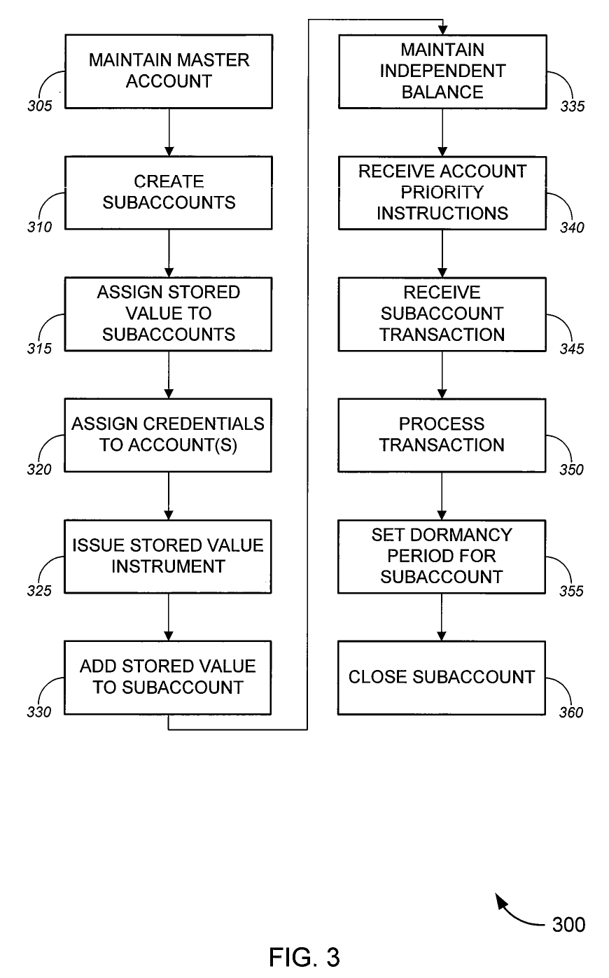

FIG. 3 illustrates a method 300 of providing financial services using stored value accounts, in accordance with a set of embodiments. The method 300 comprises maintaining a master account (block 305). In some embodiments, maintaining a master account comprises storing, in the database 110, information associated with the master account and/or obtaining the information periodically to account for transactions involving the master account. In a sense, the master account can be considered to be maintained at and/or by the host computer 105, even if the database 110 is separate from the host computer 105, because the host computer 105 generates the commands for storing and/or updating the information in the database 110. In an aspect, the master account might comprise some amount of stored value (referred to herein as “master stored value” and/or a “master amount of stored value”).

The method 300 further comprises creating one or more subaccounts (block 310). As noted above, a subaccount is represented by a set of information that is associated in some fashion with the master account. Creating a subaccount, therefore, comprises generating information to represent the subaccount. In accordance with different embodiments, this might comprise any of several different procedures, such as creating, for each subaccount, a new table in the database 110, a new record in the database 110, a set of fields in the database 110, and/or modifying any of these.

In a set of embodiments, stored value (and, in particular, shared stored value) may be assigned to one or more of these subaccounts (block 315). (In one aspect, assigning stored value to a subaccount can be considered a part of creating the subaccount. In another aspect, assigning stored value to subaccount can be considered part of managing the subaccount after its creation.) In some cases, assigning stored value to subaccount comprises allocating a portion of the master amount of stored value in the master account for use by the subaccount. (It should be noted, however, that this allocation need not necessarily be exclusive—in some cases, some portion of the master stored value might be assigned to multiple subaccounts.) Merely by way of example, the master account holder may provide (e.g., via an interface 120) instructions for creating a subaccount, and these instructions might include instructions regarding the amount of shared stored value to be assigned to the subaccount.

In an aspect, the method 300 may include assigning credentials to the master account and/or one or more subaccounts (block 320). Credentials can include any information that is used to identify an account holder and/or to verify the identity of an account holder. Such credentials might comprise, merely by way of example, a user ID, a PIN, a password, a name, and address, a phone number, and/or the like.

In some embodiments, the method 300 comprises issuing a stored value instrument associated with a master account and/or a subaccount (block 325). As noted above, in some cases, a stored value instrument might comprise a gift card (and/or another type of card), which may comprise a magnetic stripe, bar code and/or the like to allow the instrument to be read by a machine. In such cases, the instrument may be encoded with an account number for the account to which it provides access and/or with other credentials (e.g. verification credentials). In a set of embodiments, issuing an instrument may comprise initiating the issuance of the instrument. Merely by way of example, the host computer 105 might transmit, to the card issuing system 125, instructions for issuing the stored value instrument. The instructions might include, without limitation, instructions for information to be printed and/or embossed on the front of instrument, information to be encoded on the instrument (e.g., account information, verification credentials, and/or the like), the name of the instrument holder, an address to which the instrument should be sent, and/or the like.

In some cases, the master account holder may wish to increase the amount of stored value to which a particular subaccount has access. Hence, the method 300 can comprise adding stored value to one or more subaccounts (block 330). Merely by way of example, the host computer 105 might receive a request from the master account holder to add some amount of stored value to a subaccount and/or might receive funds (e.g., via a funds transfer, deposit, accounts-to-account balance transfer, and/or the like) in that amount (perhaps with the addition of a service fee). In response to the request and/or to receiving the funds, the host computer 105 might add the appropriate amount of stored value to the master account and/or increase the amount of shared stored value to which the subaccount has access (e.g., by updating the database 110 to reflect these changes).

As noted above, certain embodiments allow a holder of a stored value instrument to add stored value (referred to herein as “independent “stored value) to the account separate from the shared stored value of the master account to which the subaccount has access. Hence, in some embodiments, the method further comprises maintaining a balance of independent stored value associated with a subaccount (block 335). In this way, the instrument holder has the ability to augment the stored value made available by the master account holder. Merely by way of example, the host computer 105 might receive a request (e.g., via an interface 120) from a subaccount holder to add an amount of independent stored value to that subaccount holder's subaccount and/or might receive funds (e.g., via a funds transfer, deposit, accounts-to-account balance transfer, and/or the like) in that amount (perhaps with the addition of a service fee). In response to the request and/or the receipt of the funds, the host computer 105 adds the corresponding amount of independent stored value to the subaccount (again, perhaps by updating the appropriate entries in the database 110).

Optionally, if a subaccount has a balance of independent stored value, the instrument holder (i.e., the subaccount holder for that subaccount) may be provided with the ability to prioritize either the independent stored value or the stored value shared with the master account, such that charges against the subaccount are first debited from the prioritized stored value. Hence, the method, in some cases, further comprises receiving account priority instructions (block 340). Such instructions can include, for example, an instruction to draw from the balance of independent stored value in the subaccount before drawing from the shared stored value to which the subaccount has access. Conversely, instructions might include an instruction to draw from the shared stored value before drawing from the balance of independent stored value.

When a subaccount transaction (which, as noted above, might be a credit card transaction, an ATM transaction, a request to clear a prepaid negotiable instrument, and/or the like) is received (block 345), the host computer 105 processes that transaction (block 350). Processing the transaction may include, merely by way of example, ascertaining an amount of the transaction and debiting (or crediting, as appropriate) the subaccount associated with the transaction (as identified, for example, by the stored value instrument used in the transaction). In an embodiment, if shared stored value is used to fund the transaction, debiting the subaccount might actually comprise debiting the master account by the appropriate amount and, correspondingly, decreasing the amount of shared stored value available to the subaccount. In some cases, processing the transaction further comprises creating a database record comprising details of transaction (e.g., a merchant involved in the transaction, the amount of the transaction, the date of the transaction, the subaccount for which the transaction was performed, and/or the like), which can allow for review of the transaction at a later time. In some cases, processing the transaction might comprise collecting information from the transaction that can be used for fraud mitigation and/or dispute resolution purposes. Merely by way of example, U.S. patent application Ser. No. 11/686,697 filed Mar. 1, 2007 by Weitzman and entitled “Monitoring of Stored-Value-Instrument Usage” (the entire disclosure of which is incorporated herein by reference) describes various systems and methods for collecting data at a point of sale device, and processing a transaction might comprise storing such information, which can be used, inter alia, for such fraud mitigation and/or dispute resolution purposes.

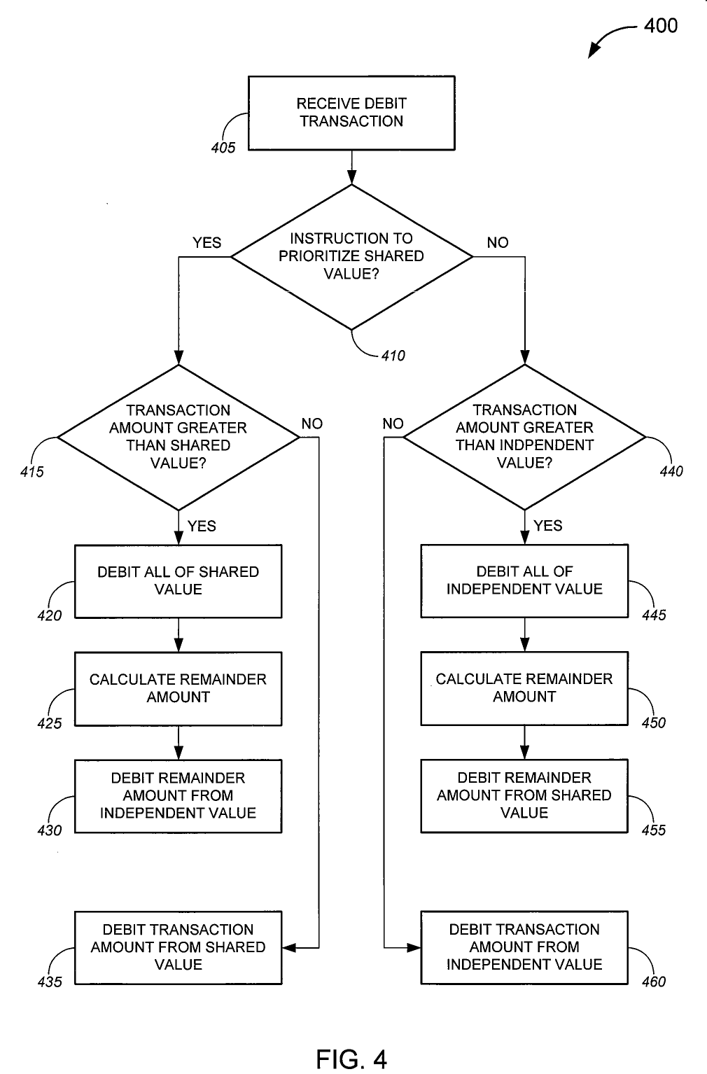

If the transaction is a debit transaction and the subaccount has a balance of independent stored value, processing the transaction can include making a determination of how to allocate the debit among the shared stored value and the independent stored value. FIG. 4 illustrates one method 400 of processing such a transaction, although it should be recognized that other methods are possible as well.

The method 400 of FIG. 4 includes receiving (e.g., at the host computer 105) a debit transaction (block 405), which might be a credit card transaction, a request to clear a prepaid negotiable instrument, an ATM withdrawal, etc. The behavior of the host computer 105 depends on whether the subaccount holder has given an instruction to prioritize the shared stored value in allocating the debit (block 410).

If the host computer has received an instruction to draw from the shared stored value (i.e., the portion of the stored value in the master account to which the subaccount has access) before drawing from the balance of the independent stored value, the host computer 105 determines whether the transaction amount (perhaps including any associated fees) is greater then the amount of shared stored value to which the subaccount has access (block 415). If so, processing the transaction comprises debiting all of the shared stored value to which the subaccount has access (block 420) and calculating a remainder amount (block 425) by subtracting the amount of shared value debited from the transaction amount. This remainder amount is then debited from the balance of the independent stored value in the subaccount (block 430). If the transaction amount is less than or equal to the amount of shared stored value to which the subaccount has access, the transaction amount is simply debited from the shared stored value (block 435). As noted above, in debiting from the shared stored value, the host computer 105 may actually debit from the master amount of stored value in the master account, and reduce the amount of shared stored value to which the subaccount has access correspondingly.

By contrast, if the host computer 105 has received an instruction to prioritize the independent stored value (i.e., an instruction to draw from the balance of the independent stored value in the first subaccount before drawing from the shared portion of stored value to which the subaccount has access), or has received no instruction on prioritizing debits, processing the transaction will comprise determining whether the debit transaction has an amount greater than the balance of the independent stored value in the subaccount (block 440). If so, the method 400 comprises debiting all of the independent stored value (block 445) and calculating a remainder amount (block 450) by subtracting the amount of the debited independent stored value from the transaction amount. The shared value to which the subaccount has access is then debited by the remainder amount (block 455). (As noted above, debiting the shared value may comprise debiting the stored value in the master account and reducing the amount of shared stored value to which the subaccount has access accordingly.) If the transaction amount is less than or equal to the balance of independent stored value, the transaction amount will simply be debited from the balance of the independent stored value (block 460).

In the above example, it was assumed that the default behavior of the host computer 105 (i.e., in the event no prioritization instruction had been received) was to prioritize the independent stored value in the subaccount. It should be appreciated, however, that other default behaviors for the host computer 105 can be configured. Merely by way of example, the host computer 105 may be configured, by default, to debit first from the shared stored value. Alternatively the host computer 105 might be configured to debit the independent stored value in the shared stored value in equal amounts and/or in proportion to the respective can be specified by the instrument holder when providing prioritization instructions to the host computer 105.

Returning to FIG. 3, in some cases, the method 300 comprises setting a dormancy period for the subaccount (block 355). If the subaccount (or, more particularly, in some cases, a stored value instrument associated with the subaccount) is not used within a period of time specified by the dormancy period, the subaccount may be closed (block 360). In an aspect, closing the subaccount may include deactivating the stored value instrument associated with the account. In this case, any shared stored value to which the subaccount has access may simply revert back to the master account (as opposed to escheating to the state, for example), since the shared stored value “belongs” to the master account in any event—the subaccount, while it existed, merely had access to the shared stored value.

By contrast, the disposition of any independent stored value in a closed subaccount may depend on the configuration of the accounts and/or applicable regulations. In some cases, for example, regulations may require that the independent stored value in the subaccount escheat to the state (or other governing authority). In other cases, the independent stored value may revert to the master account associated with the subaccount. In yet other cases, a negotiable instrument (such as a check, etc.) may be issued to the subaccount holder, if that holder can be personally identified. A variety of options are available in this situation, and in an aspect, the host computer 105 may be configured to employ any of such options.

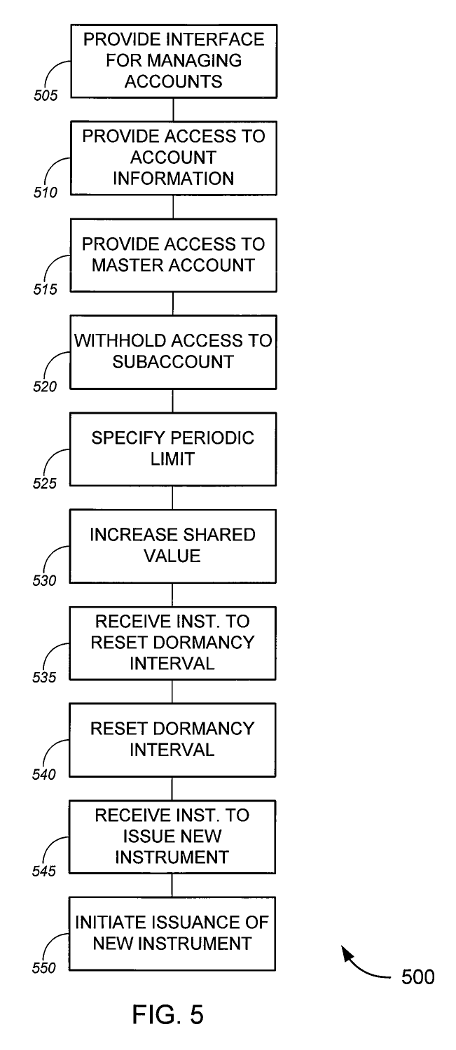

Various embodiments of the invention provide flexible options for the management of stored value accounts. FIG. 5 illustrates several procedures (collectively referenced by numeral 500) that may be used to manage stored value accounts in accordance with some such embodiments. In some cases, an interface is provided (block 505), allowing a master account holder to manage a master account and/or one or more subaccounts (e.g., via various procedures 500) and/or for allowing a subaccount holder to manage the subaccount(s) to which the subaccount holder has access.

As noted above, a variety of interfaces may be provided for managing accounts. Such interfaces can include a web interface 115a, a telephone interface 115b, and/or a POS interface 115c, among others. Access to the procedures 500 (via an interface 115 or otherwise) may be controlled, e.g., by requiring a user seeking such access to provide identification and/or validation credentials, such as those described above, before performing such procedures.

Procedures 500 for managing an account may include providing access to account information. This information can include, without limitation, information about an original balance of stored value in an account, a remaining balance of stored value an account, recent transactions performed with respect to the account, transactions pending for the account, all transactions for the account, and/or like. This information can be provided via an interface, a printed report, an electronic mail message, and/or the like. In this way, the master account holder (and/or a subaccount holder) can audit the usage of the stored value.

In some cases, the master account holder is provided with access to account information about the master account and/or the shared stored value in associated subaccounts (block 510). In other cases, however, the system will withhold from the master account holder information about any independent stored value in the subaccount (block 520), in order to preserve the privacy of the subaccount holder. (In an aspect, it is assumed that the subaccount holder will have no privacy interests in transactions associated with shared stored value, since the master account were has authority and/or responsibility over that shared stored value, which is just an assigned portion of the master stored value in the master account. By contrast, the independent stored value may represent the subaccount holder's own funds, over which the master account holder should not have oversight.)

In accordance with some embodiments, other tools may be provided to facilitate control by the master account holder over spending by the instrument holder(s). Merely by way of example, the master account holder may be provided with the ability to set periodic spending limits for one or more of the subaccounts (block 525). For instance, the master account holder might specify a maximum amount of shared value (or, more precisely, in some cases, shared stored value) in the subaccount that can be used over any given period (such as one or more hours, days, months, quarters, years, and/or the like). Hence, within the specified periodic interval, the subaccount only would have access to this specified maximum amount of shared stored value.

In some cases, the host system 105 might receive instructions (e.g., from the master account holder) to increase the amount of shared stored value to which a particular subaccount has access (block 530), and the portion of the master stored value that is shared with the subaccount (i.e., to which the subaccount has access) may be increased accordingly. As noted above, this may (or may not) be associated with the receipt of additional funds to increase the master amount of stored value.

Also as noted above, a dormancy interval might be specified for a subaccount, such that if the subaccount (and/or a stored instrument associated with the subaccount) is not used within the dormancy interval and the subaccount may be closed and/or instrument may be deactivated. In such cases, the master account holder may be given various options to govern the operation of the dormancy interval. For instance, the master account holder may be given the option to reset the dormancy interval. Merely by way of example, the master account holder might provide an instruction to reset the dormancy interval. Upon receiving such an instruction (block 535), e.g., via an interface 115, the host computer 105 resets the dormancy interval (block 540) (e.g., by updating the database 110 as if a transaction involving the subaccount had been received), preventing the closure of the subaccount for dormancy.

If a subaccount has been closed (and/or an associated stored value instrument has been deactivated) for dormancy, the master account holder might wish to reinstate the subaccount. In such a case, the master account holder might provide an instruction to reissue a stored value instrument associated with the subaccount. Upon receiving such an instruction (block 545), the host computer may reinstate the subaccount (perhaps with parameters earlier established for the subaccount and/or new parameters provided by the master account holder with the request) and/or initiate the issuance of a new stored value instrument to be associated with the subaccount (block 550), perhaps in the manner described above.

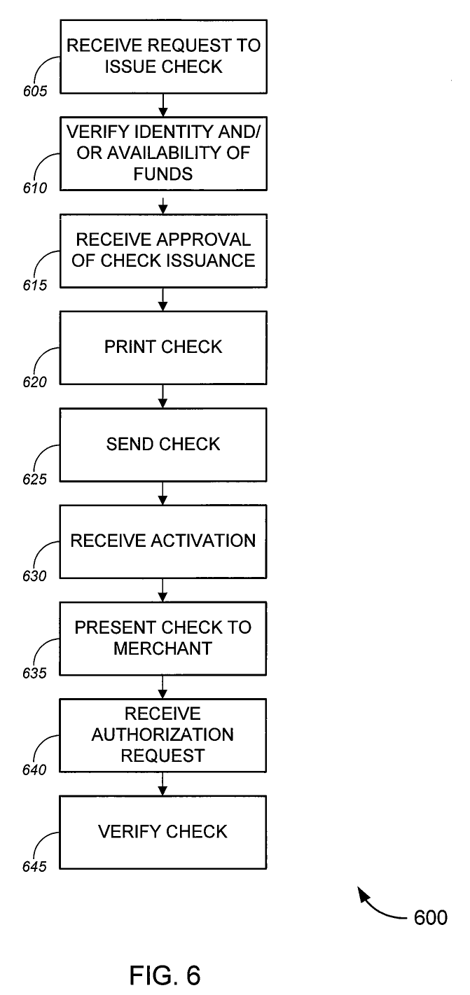

In a set of embodiments, a prepaid negotiable instrument (such as a prepaid check) can be drawn against one or more of the subordinate accounts (or for that matter, the master account). U.S. patent application Ser. No. 11/558,874, filed Nov. 10, 2006 by Weitzman and entitled “System and Method for Issuing Prepaid Negotiable Instruments,” discloses several embodiments for issuing prepaid negotiable instruments, which are incorporated herein by reference. Such instruments, methods and systems may be employed by various embodiments of the present invention. Merely by way of example, FIG. 6 illustrates a method 600 of providing a prepaid negotiable instrument to a holder of a subaccount (e.g., a holder of a stored value instrument associated with a subaccount) in accordance with a set of embodiment. The method 600 is described with respect to the system 100, although it should be appreciated that the method 600 can be performed using any suitable hardware arrangement.

The method 600 comprises receiving, at the host computer and/or from a user (e.g., the subaccount holder), a request for a check be issued by the financial institution (block 605) using stored value in a subaccount. As one example, the user might provide an account identifier and/or requested amount via any of the interfaces 115 described above. The system may also be configured to receive verifying credentials, such as those described above, to assure the person making the request is authorized to do so. Such information can be checked and/or verified by the host computer 105 against account data within the database 110. In response to the request, the host computer 105 verifies identity of the user and/or the subaccount, and verifies that there is sufficient stored value in the subaccount to cover the amount of the requested check. In some embodiments, the system uses a previously-specified priority preference to determine whether to draw the funds from shared stored value and/or independent stored value (perhaps using a method similar to the method 500 of FIG. 5). In other embodiments, the system may prompt (e.g., via an interface 115) the user to identify whether shared or independent stored value should be the primary source of funds for the check. In some cases, the system will ensure that the requested check would not violate any periodic or other spending limitations imposed on the subaccount. Optionally, the system may provide to the customer the prior balance (before the transaction) of the relevant stored value, the amount of any fees, and/or the remaining balance (after the transaction), so that if the user wants to request an additional check, the amount available for such check will be known.

The user is then prompted to approve the issuance of the check, and when such approval is received by the host computer 105 (block 615), the host 105 allocates the amount of the check from the relevant stored value in the subaccount (and, optionally, reduces the amount of stored value and/or the amount of shared stored value available to the subaccount), and instructs the printer 135 to print a check with information relevant to the transaction (block 620). In one embodiment, the printed check includes (in human readable form) the amount of the check and/or a transaction number associated with the requested transaction, printed on the face of the check. In other embodiments, the check may further include encoded information, in the event the payee or merchant has equipment for electronically reading the check (check number, account number, routing number). The encoded information may be printed using magnetic ink code recognition (“MICR”) technology, bar code technology and/or the like. In some embodiments, the transaction number and check amount can also be encoded so as to be electronically read.

The system then sends the check to the user (and/or another recipient selected by the user (block 625). As should be appreciated, the check may be transmitted in various ways. Merely by way of example, the check could be sent via mail, courier (e.g. overnight delivery) or other suitable means. Alternatively and/or additionally, sending the check might comprise holding the check at an agent location for the user (and/or an authorized designee) to pick up.

Once the customer receives the check, the check is activated by the user, and the activation transaction is received by the host computer (block 630). This activation might be received by the host computer 105 via one or more of the interfaces 120. As an example, the user may telephone the issuer and provide check identifying information (check number, transaction number, etc.) and then a verifying credential. In one embodiment, until the check is activated by the customer, it cannot be used for payment, i.e., the system will not recognize a request by a merchant or other party to authorize the check for payment. This steps prevents loss from theft or misappropriation of the check while in transit, since the person having the check under such circumstances will not have the unique personal identifier, and until such time as the customer activates the check it cannot be used to conduct a transaction.

After the check has been activated, the customer may at any time present the check to a merchant or other payee for payment (block 635). In some embodiments, the merchant is required to submit an authorization request, which is received at the host computer (block 640) e.g., via one or more of the interfaces 120. The authorization request might include check identifying information (e.g., transaction number and amount). As part of the authorization process, the host computer 105 might provide verification that the check is valid (for the specified amount) (block 645). Optionally, the host completes 105 a record of the transaction so that the same check (and/or transaction number) cannot be used for a subsequent transaction.

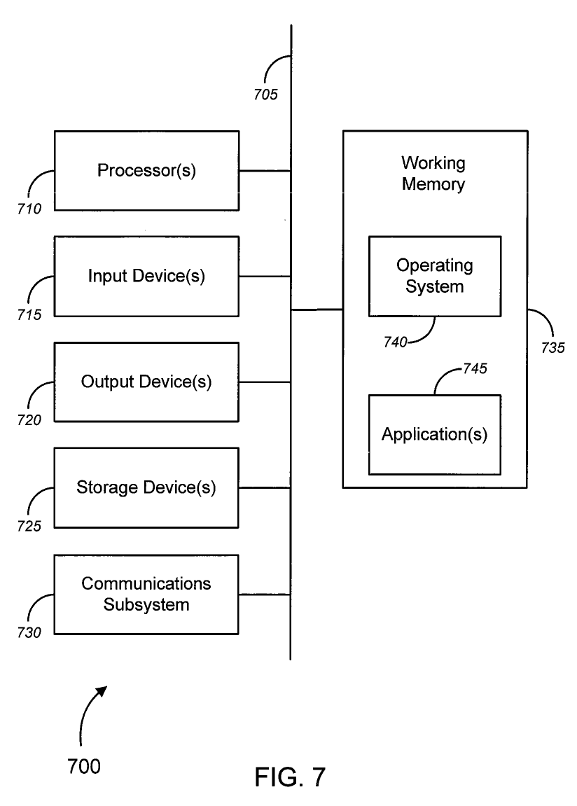

FIG. 7 provides a schematic illustration of one embodiment of a computer system 700 that can perform the methods of the invention, as described herein, and/or can function as a host computer, a user computer, a POS device, and/or the like. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can electrically coupled via a bus 705 (or may otherwise be in communication, as appropriate). The hardware elements can include one or more processors 710, including without limitation one or more general-purpose processors and/or one or more special-purpose processors (such as digital signal processing chips, graphics acceleration chips, and/or the like); one or more input devices 715, which can include without limitation a mouse, a keyboard and/or the like; and one or more output devices 720, which can include without limitation a display device, a printer and/or the like.

The computer system 700 may further include (and/or be in communication with) one or more storage devices 725, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 700 might also include a communications subsystem 730; which can include without limitation a modem, a network card (wireless or wired), an infra-red communication device, and/or the like), a wireless communication device and/or chipset (such as a Bluetooth™ device, an 802.11 device, a WiFi device, a WiMax device, cellular communication facilities, etc.). The communications system 730 may permit data to be exchanged with a network (such as the network 610 described below, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740 and/or other code, such as one or more application programs 745, which may comprise computer programs of the invention and/or may be designed to implement methods of the invention, as described herein. Merely by way of example, one or more procedures described with respect to the method(s) discussed above might be implemented as instructions executable by a computer (and/or a processor within a computer). A set of these instructions might be stored on a computer-readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), such that the storage medium can be used to program a generic computer with the instructions stored thereon. These instructions might take the form of executable code, which is executable by the computer system 700 and/or might take the form of installable code, which, upon installation on the computer system 700 (e.g., using any of a variety of generally available installation programs, compression/decompression utilities, etc.) then takes the form of executable code.

It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

In one aspect, the invention employs a computer system (such as the computer system 700) to perform methods of the invention. According to a set of embodiments embodiment, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another machine-readable medium, such as one or more of the storage device(s) 725. Merely by way of example, execution of the sequences of instructions contained in the working memory 735 causes the processor(s) 710 to perform one or more procedures of the methods described herein.

The term “machine-readable medium” as used herein refers to any medium that participates in providing data that causes a machine to operation in a specific fashion. In an embodiment implemented using the computer system 700, various machine-readable media might be involved in providing instructions to processor(s) 710 for execution. In many implementations, a machine-readable medium is a physical and/or tangible medium. Such a medium may take many forms, including but not limited to, non-volatile media, volatile media, and transmission media. Non-volatile media includes, for example, optical or magnetic disks, such as the storage device(s) 725. Volatile media includes, without limitation dynamic memory, such as the working memory 735. Transmission media includes coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves, including without limitation radio, acoustic and/or light waves, such as those generated during radio-wave and infra-red data communications.

Common forms of physical and/or tangible machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to the processor(s) 710 for execution. Merely by way of example, the instructions may initially be carried on a magnetic disk and/or optical disc of a remote computer. The remote computer might load the instructions into its dynamic memory and send the instructions as signals over a transmission medium. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

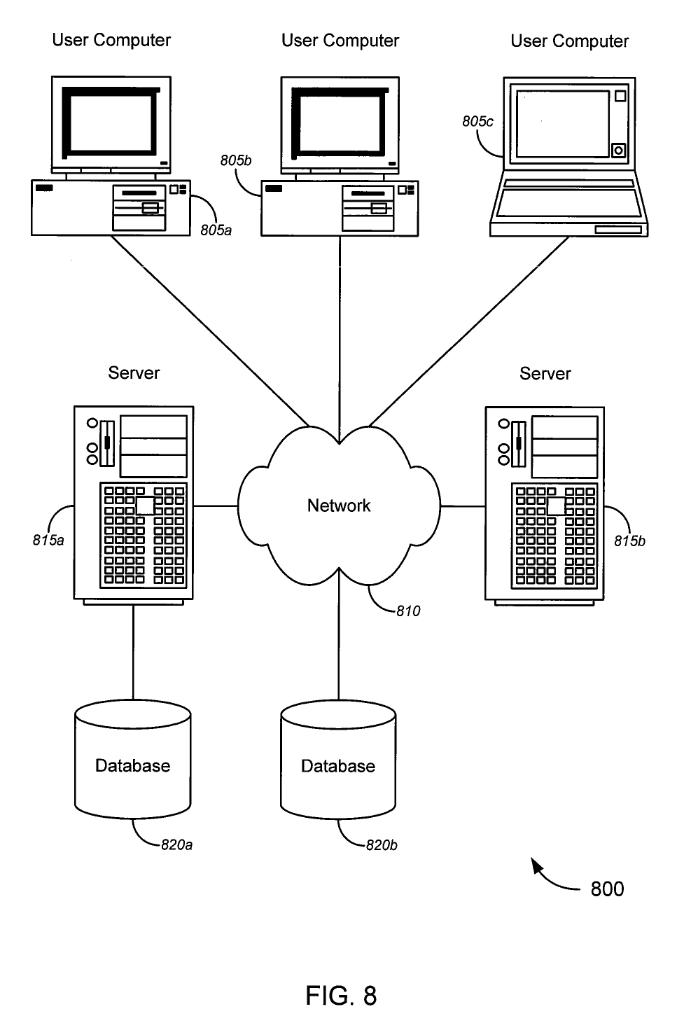

FIG. 8 illustrates a block diagram of a system 800 that can be used in accordance with one set of embodiments. The system 800 can include one or more user computers 805 that can be used to access information about stored value accounts, create and/or manage those accounts (perhaps by providing instructions to a host computer), and/or the like, via the one or more of the interfaces 120 described above. The user computers 805 can be general purpose personal computers (including, merely by way of example, personal computers and/or laptop computers (including, merely by way of example, personal computers and/or Apple Corp.'s Macintosh™ operating systems) and/or workstation computers running any of a variety of commercially-available UNIX™ or UNIX-like operating systems. These user computers 805 can also have any of a variety of applications, including one or more applications configured to perform methods of the invention, as well as one or more office applications, database client and/or server applications, and web browser applications. Alternatively, the user computers 805 can be any other electronic device, such as a thin-client computer, Internet-enabled mobile telephone, and/or personal digital assistant, capable of communicating via a network (e.g., the network 810 described below) and/or displaying and navigating web pages or other types of electronic documents. Although the exemplary system 800 is shown with three user computers, any number of user computers can be supported.

Certain embodiments of the invention operate in a networked environment, which can include a network 810. The network 810 can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 815 (one or more of which may function as a host 105 in accordance with embodiments of the invention). Each of the server computers 815 may be configured with an operating system including without limitation any of those discussed above, as well as any commercially-available server operating systems, mainframe operating systems, and/or the like. Each of the servers 815 may also be running one or more applications, which can be configured to provide services to one or more clients 805 and/or other servers 815.

Merely by way of example, one of the servers 815 may be a web server, which can be used, merely by way of example, to process requests for web pages or other electronic documents from user computers 805. The web server can also run a variety of server applications, including HTTP and/or HTTPS servers, FTP and/or SFTP servers, CGI servers, database servers, Java servers, and the like. In some embodiments of the invention, the web server may be configured to serve web pages that can be operated within a web browser on one or more of the user computers 805 to perform methods of the invention.

In some embodiments, a web server and/or an application server can create web pages dynamically for displaying the information in accordance with embodiments of the invention, such as for providing access to account information, receiving instructions for account management, and/or the like. Data provided by an application server may be formatted as web pages forwarded to a user computer 805 via an interface (such as a web server), transmitted via an IVR interface, etc. Similarly, a web server might receive web page requests and/or input data from a user computer 805 and/or forward the web page requests and/or input data to an application server, host computer and/or the like.

In certain embodiments, the system can include one or more databases 820 (which can function as the databases 110 and 200 described above). The location of the database(s) 820 is discretionary: merely by way of example, a database 820a might reside on a storage medium local to (and/or resident in) a server 815a (and/or a user computer 805). Alternatively, a database 820b can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 835 can be a relational database, such as an Oracle database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A system for providing financial services, the system comprising:
one or more processors;
a database in communication with the one or more processors, the database being configured to store information about a plurality of stored value accounts; and
a computer readable medium having stored thereon a set of instructions executable by the one or more processors, the set of instructions comprising:
instructions for maintaining, in the database, a record for a master account having a master amount of stored value, the master account being associated with a master accountholder, who is responsible for the master account;
instructions for creating, in the database, a record for a first subaccount, the first subaccount being subordinate to the master account, the first subaccount having access to a first amount of stored value, the first amount of stored value comprising a first portion, to which the first subaccount has access, of the master amount of stored value;
instructions for creating, in the database, a record for a second subaccount, the second subaccount being subordinate to the master account, the second subaccount having access to a second amount of stored value, the second amount of stored value comprising a second portion, to which the subaccount has access, of the master amount of stored value;
instructions for initiating issuance, to a first instrument holder, of a first stored value instrument that provides access to the first subaccount; and
instructions for initiating issuance, to a second instrument holder, of a second stored value instrument that provides access to the second subaccount.

2. The system of claim 1, further comprising:
an interface configured to allow communication between one or more users and the one or more processors;
wherein the set of instructions further comprises:
instructions for receiving communications from the master accountholder for managing the master account.

3. The system of claim 1, further comprising:
a card issuing system configured to issue the first stored value instrument responsive to the instructions to initiate issuance of the first stored value instrument.

4. A method of providing financial services, the method comprising:
maintaining, at a host computer system, a master account having a master amount of stored value, the master account being associated with a master accountholder, who is responsible for the master account;
creating, at the host computer system, a first subaccount, the first subaccount being subordinate to the master account, the first subaccount having access to a first amount of stored value, the first amount of stored value comprising a first portion, to which the first subaccount has access, of the master amount of stored value;
creating, at the host computer system, a second subaccount, the second subaccount being subordinate to the master account, the second subaccount having access to a second amount of stored value, the second amount of stored value comprising a second portion, to which the subaccount has access, of the master amount of stored value;
initiating issuance, to a first instrument holder, of a first stored value instrument that provides access to the first subaccount; and
initiating issuance, to a second instrument holder, of a second stored value instrument that provides access to the second subaccount.

5. The method of claim 4, further comprising:
initiating issuance, to a holder of the master account, a master stored value instrument that provides access to the master account.

6. The method of claim 4, wherein the first stored value instrument comprises a gift card, the gift card comprising a magnetic stripe.

7. The method of claim 6, wherein the gift card is configured for use on a credit card network, such that the gift card is used to process a credit card transaction, and wherein the method further comprises:
debiting the master account by an amount of the credit card transaction; and
reducing the first amount of stored value, to which the first subaccount has access, by the amount of the credit card transaction.

8. The method of claim 4, further comprising:
receiving, from the master accountholder, a request to add a third amount of stored value to the first subaccount;
receiving funds in the at least third amount;
adding, in response to the request, the third amount of stored value to the master account; and
increasing, in response to the request, the first amount of stored value, to which the first subaccount has access, by the third amount of stored value.

9. The method of claim 4, further comprising:
receiving, from the first instrument holder, a request to add a third amount of stored value to the first subaccount;
receiving funds in at least the third amount;
adding, in response to the request, the third amount of stored value to the first subaccount.

10. The method of claim 9, further comprising:
maintaining a balance of independent stored value in the first subaccount, based on the third amount of stored value added to the first subaccount, separate from the from the first portion of the master amount of stored value to which the first subaccount has access.

11. The method of claim 10, further comprising:
receiving, from the first instrument holder, an instruction to draw from the balance of independent stored value in the first subaccount before drawing from the first portion of the master amount of stored value to which the first subaccount has access;
receiving a debit transaction involving the first subaccount; and
processing the debit transaction.

12. The method of claim 11, wherein the debit transaction is a credit card transaction involving the first stored value instrument.

13. The method of claim 11, wherein processing the debit transaction comprises:
if the debit transaction has an amount less than or equal to the balance of independent stored value in the first subaccount, debiting the balance of independent stored value in the first subaccount by the amount of the debit transaction; and
if the debit transaction has an amount greater than the balance of independent stored value in the first subaccount:
debiting the balance of independent stored value by an amount of the balance of independent stored value;
calculating a remainder amount by subtracting the amount of the balance of independent stored value from the amount of the debit transaction;
debiting the master amount of stored value by the remainder amount; and
reducing the first amount of stored value to which the first subaccount has access by the remainder amount.

14. The method of claim 10, further comprising:
receiving, from the first instrument holder, an instruction to draw from the first portion of the master amount of stored value to which the first subaccount has access before drawing from the balance of independent stored value in the first subaccount;
receiving a debit transaction involving the first subaccount; and
processing the debit transaction.

15. The method of claim 14, wherein processing the debit transaction comprises:
if the debit transaction has an amount less than or equal to first amount of stored value to which the first subaccount has access, debiting the master amount of stored value by the amount of the debit transaction and reducing first amount of stored value to which the first subaccount has access by the amount of the debit transaction; and
if the debit transaction has an amount greater than the first amount of stored value to which the first subaccount has access:
debiting the master amount of stored value by the first amount of stored value to which the subaccount has access;
reducing the first amount of stored value to which the subaccount has access to zero;
calculating a remainder amount by subtracting the amount debited from the master amount of stored value from the amount of the debit transaction; and
debiting the balance of independent stored value by the remainder amount.

16. The method of claim 10, further comprising:
providing the master accountholder with access to account information about the first subaccount.

17. The method of claim 16, wherein the account information comprises information about transactions made with the first stored value instrument.

18. The method of claim 16, wherein providing the master accountholder with access to account information about the first subaccount comprises:
providing the master accountholder with access to account information about the first portion of the master account to which the first subaccount has access; and
withholding, from the master accountholder, access to account information about the balanced of independent stored value in the first subaccount.

19. The method of claim 4, wherein the master accountholder is an employee, and wherein the first and second instrument holders are employees of the employer.

20. The method of claim 4, further comprising:
providing an interface to the host computer system for allowing the master accountholder to manage the master account.

21. The method of claim 20, wherein the interface allows the first instrument holder to manage the first subaccount.

22. The method of claim 21, wherein allowing the first instrument holder to manage the first subaccount comprises:
receiving, at the host computer system and via the interface, a request from the first instrument holder for a negotiable instrument, including a request to allocate, from the first subaccount, a third amount of funds for the negotiable instrument;
allocating the third amount from the first subaccount;
providing a stock of physical, blank negotiable instruments at an issuing location apart from the first instrument holder;
in response to allocating the third amount, printing at the issuing location and on one of the stock of blank negotiable instruments, identification information that identifies the negotiable instrument; and
providing the printed negotiable instrument to the first instrument holder as the requested negotiable instrument.

23. The method of claim 20, wherein the interface comprises a web interface.

24. The method of claim 20, wherein the interface comprises a telephone interface.

25. The method of claim 20, wherein allowing the master accountholder to manage the master account comprises:
receiving, from the master accountholder, first instructions specifying the first portion, to which the first subaccount has access, of the master amount of stored value; and
receiving, from the master accountholder, second instructions specifying the second portion, to which the second subaccount has access, of the master amount of stored value.

26. The method of claim 20, wherein allowing the master accountholder to manage the master account comprises:
receiving, from the master accountholder, instructions specifying a periodic limit on the first subaccount, the periodic limit specifying a third amount of stored value and an periodic interval, wherein the first amount of stored value to which the first subaccount has access is limited, such that, within a period of time specified by the periodic interval, the first subaccount has access only to the third amount of stored value.

27. The method of claim 26, wherein the periodic interval is selected from the group consisting of a daily interval, a weekly interval, a monthly interval, a quarterly interval, and an annual interval.

28. The method of claim 20, wherein allowing the master accountholder to manage the master account comprises:
receiving, from the master account holder, instructions to increase the first amount of stored value to which the first subaccount has access; and
increasing, in response to the instructions, the first portion of the master amount of stored value to which the first subaccount has access.

29. The method of claim 20, wherein the first subaccount has associated with a dormancy interval, wherein, if the first stored value instrument is not used within the dormancy interval, the first stored value instrument is deactivated.

30. The method of claim 29, wherein allowing the master accountholder to manage the master account comprises:
receiving, from the master accountholder, instructions to reset the dormancy interval; and
in response to the instructions, resetting the dormancy interval.

31. The method of claim 29, wherein allowing the master accountholder to manage the master account comprises:
receiving, from the master accountholder, instructions to issue a new stored value instrument, after the first stored value instrument has been deactivated; and
initiating issuance, to the first instrument holder, of the new stored value instrument, the new stored value instrument providing access to the first subaccount.

32. The method of claim 4, further comprising:
setting a dormancy period for the first subaccount, the dormancy period specifying an interval of non-use of the first stored value instrument, after which the first stored value instrument will be deactivated;
upon expiration of the dormancy period:
deactivating the first stored value instrument, such that the first stored value instrument no longer provides access to the first subaccount; and
closing the first subaccount, such that the first subaccount no longer has access to any portion of the master amount of stored value, wherein closing the first subaccount has no effect on a magnitude of the master amount of stored value.

33. A computer readable medium having stored thereon a computer program comprising a set of instructions executable by one or more processors, the set of instructions comprising:
instructions for maintaining, at a database in communication with the one or more processors, a master account having a master amount of stored value, the master account being associated with a master accountholder, who is responsible for the master account;
instructions for creating, in the database, a first subaccount, the first subaccount being subordinate to the master account, the first subaccount having access to a first amount of stored value, the first amount of stored value comprising a first portion, to which the first subaccount has access, of the master amount of stored value;
instructions for creating, in the database, a second subaccount, the second subaccount being subordinate to the master account, the second subaccount having access to a second amount of stored value, the second amount of stored value comprising a second portion, to which the subaccount has access, of the master amount of stored value;
instructions for initiating issuance, to a first instrument holder, of a first stored value instrument that provides access to the first subaccount; and
instructions for initiating issuance, to a second instrument holder, of a second stored value instrument that provides access to the second subaccount.
